(19) United States
(12) Patent Application Publication
(10) Pub. No.: US 2007/0165665 A1
(43) Pub. Date: Jul. 19, 2007

(54) System and method for access control in wireless networks

(76) Inventors: Sudhanshu Gaur, Burlingame, CA (US); Clifford Tavares, San Carlos, CA (US)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/332,456

(22) Filed: Jan. 13, 2006

(51) Int. Cl. H04L 12/413

(52) U.S. Cl. 370/445

(57) ABSTRACT

A method comprises obtaining a frame of information in an access class to be communicated over a wireless channel; determining whether the wireless channel is idle; selecting a random arbitration interframe space based on the access class of the frame; waiting a first time period pertaining to the arbitration interface space; and initiating communication of the frame of information over the wireless channel after the first time period. The method may further comprise, before initiating communication of the frame of information, selecting a random backoff time period and waiting a second time period pertaining to the backoff time period. The random arbitration interframe space may be selected from a predetermined set of values. The number of values in the predetermined set may be associated with the number of possible stations transmitting in the access class.

### TECHNICAL FIELD

This invention relates generally to wireless communication protocols, and more particularly provides a system and method for access control in wireless networks.

### BACKGROUND

As users experience the convenience of wireless connectivity, they are demanding support for the same applications they run over wired networks. Because wireless bandwidth availability is restricted, quality of service (QoS) is increasingly important in 802.11 networks. IEEE 802.11e proposes to define QoS mechanisms for wireless gear that gives support to bandwidth-sensitive applications such as voice and video.

The original 802.11 media access control protocol was designed with two modes of communication for wireless stations. The first mode, Distributed Coordination Function (DCF), is based on Carrier Sense Multiple Access with Collision Avoidance (CSMA/CA), sometimes referred to as “listen before talk.” A station waits for a quiet period on the network and begins to transmit data and detect collisions. The second mode, Point Coordination Function (PCF), supports time-sensitive traffic flows. Wireless access points periodically send beacon frames to communicate network identification and management parameters specific to the wireless network. Between sending beacon frames, PCF splits the time into a contention-free period and a contention period. A station using PCF transmits data during contention-free polling periods.

Because DCF and PCF do not differentiate between traffic types or sources, the IEEE proposed enhancements to both coordination modes to facilitate QoS. These changes are intended to fulfill critical service requirements while maintaining backward-compatibility with current 802.11 standards.

Enhanced Distribution Coordination Function (EDCF) introduces the concept of traffic categories. Each station has eight traffic categories, or priority levels. Using EDCF, stations try to send data after detecting that the medium is idle and after waiting a set time period called the Arbitration Interframe Space (AIFS) defined by the corresponding traffic category. A higher-priority traffic category will have a shorter AIFS than a lower-priority traffic category. Thus, stations with lower-priority traffic must wait longer than those with high-priority traffic before trying to access the medium.

To reduce the chance of collisions within a traffic category, the station counts down an additional random number of time slots, known as a contention window, before attempting to transmit data. If another station transmits before the countdown has ended, the station waits for the next idle period. No guarantees of service are provided, but EDCF establishes a probabilistic priority mechanism to allocate bandwidth based on traffic categories.

More specifically, the IEEE 802.11e standard provides QoS differentiation by grouping traffic into access classes (ACs) with different priorities. Traffic prioritization is accomplished by using the Enhanced Distribution Coordination Access (EDCA) parameters—AIFS interval, contention window (CW), and transfer opportunity (TXOP)—defined on a per-class basis, to ensure that each class has different probabilities of accessing the channel. The IEEE 802.11e standard requires that each station wait for a fixed time interval determined by the AIFSN value assigned to the AC to which it belongs. After sensing that the medium is idle for the AIFS time interval, each station then calculates its own random backoff time. This mechanism attempts to ensure traffic separation within an AC, as shown in FIG. 1.

FIG. 1 is a timing diagram illustrating details of a prior art EDCF contention control protocol. As shown, as soon as the medium as noted as idle, information being transmitted for station 1 in access class 1 (“STA-A1”) is postponed for the AIFS interval for access class 1 (“AIFS[AC1]”). Similarly, information being transmitted for station k in access class 1 (“STA-Ak”) is postponed also for the AIFS interval for access class 1 (“AIFS[AC1]”). The information being sent by station 1 and the information being sent by station 2 are each additionally postponed a random number of backoff slots to reduce the likelihood of collision. Information being transmitted for station 1 in access class 2 (“STA-B1”) is postponed for the AIFS interval for access class 2 (“AIFS[AC2]”), which information is of lower priority than the information of access class 1 and which AIFS[AC2] is greater than AIFS[AC1]. As is well known, the AIFS values are greater than the DCF interframe space (“DIFS”), which is greater than the PCF interframe space (“PIFS”), which is greater than the short interframe space (“SIFS”).

As the number of stations within an AC increase, the probability of two or more stations choosing the same backoff value leading to packet collision also increases. Accordingly, a system and method to reduce the chance of data collisions are needed.

### SUMMARY

As stated above, stations STA-A1 and STA-Ak are transmitting information in access class 1. Each waits the same AIFS interval for access class 1. However, according to an embodiment of the present invention, every station chooses a random AIFSN value, which is an integer preferably drawn from a uniform distribution over a predetermined interval [N, M], where N and Mare predetermined integers specific to an AC. Such a mechanism can reduce the number of stations within an AC choosing the same AIFSN value, thus further reducing the probability of two or more stations choosing the same backoff value. As a result, packet collision probability is reduced, thereby resulting in greater opportunity for the nodes belonging to other ACs to access the channel. The randomization of the AIFSN value can better spread traffic within an AC and improve the overall network performance.

In one embodiment, the method comprises obtaining a frame of information in an access class to be communicated over a wireless channel; determining whether the wireless channel is idle; selecting a random arbitration interframe space based on the access class of the frame; waiting a first time period pertaining to the arbitration interface space; and initiating communication of the frame of information over the wireless channel after the first time period. The method may further comprise, before initiating communication of the frame of information, selecting a random backoff time period and waiting a second time period pertaining to the backoff time period. The random arbitration interframe space may be selected from a predetermined set of values. The number of values in the predetermined set may be associated with the number of possible stations transmitting in the access class.

In another embodiment, the system comprises a frame of information in an access class to be communicated over a wireless channel; a medium monitor for determining whether the wireless channel is idle; an AIFS module for selecting a random arbitration interframe space based on the access class of the frame and waiting a first time period pertaining to the arbitration interface space; and a transmission module for initiating communication of the frame of information over the wireless channel after the first time period. The system may further comprise a backoff module for, before initiating communication of the frame of information, selecting a random backoff time period and waiting a second time period pertaining to the backoff time period. The random arbitration interframe space may be selected from a predetermined set of values. The number of values in the predetermined set may be associated with the number of possible stations transmitting in the access class.

### BRIEF DESCRIPTION OF THE DRAWINGS

FIG. 1 is a block diagram of an IEEE 802.11e EDCA-based channel access timing diagram in accordance with the prior art.

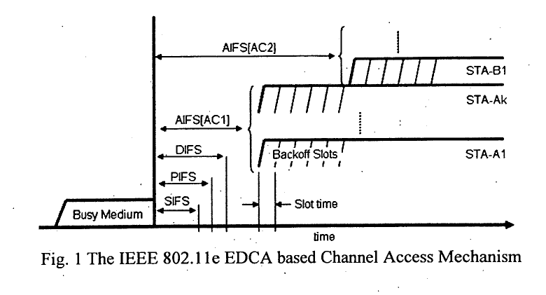

FIG. 2 is a block diagram illustrating details of a channel access timing diagram in accordance with an embodiment of the present invention.

FIG. 3 is a flowchart illustrating details of a method of controlling contention in a channel access system in accordance with an embodiment of the present invention.

FIG. 4 is a block diagram illustrating a wireless network in accordance with an embodiment of the present invention.

FIG. 5 illustrates details of the access protocol module 415 in accordance with an embodiment of the present invention.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

As stated above, stations STA-A1 and STA-Ak are transmitting information in access class 1. Each waits the same AIFS interval for access class 1. However, according to an embodiment of the present invention, every station chooses a random AIFSN value, which is an integer preferably drawn from a uniform distribution over a predetermined interval [N, M], where N and M are predetermined integers specific to an AC. Such a mechanism can reduce the number of stations within an AC choosing the same AIFSN value, thus further reducing the probability of two or more stations choosing the same backoff value. As a result, packet collision probability is reduced, thereby resulting in greater opportunity for the nodes belonging to other ACs to access the channel. The randomization of the AIFSN value can better spread traffic within an AC and improve the overall network performance.

For a given AC, the integers N and M can be chosen very close to the default AIFSN value as specified in IEEE 802.11e such that M>N≧AIFSN[AC]. For example, for video traffic, the 802.11e standard specifies an AIFSN value of 2. A method in accordance with an embodiment of the present invention can have video nodes choosing the AIFSN value randomly from the set [2, 3] or [2, 3, 4]. The optimum set of values for N and M can be determined iteratively. In another embodiment, the method can have voice nodes choosing from [2, 3], video nodes choosing from [3, 4, 5] and best effort nodes choosing from [6, 7, 8, 9, 10]. Different permutations are possible. Each node type need not choose from the same number of values in each set. The number of values in a set may be determined based on the number of possible stations of that type in the network.

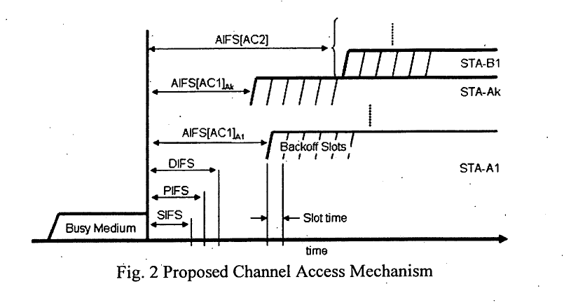

In one embodiment, the protocol may require each station to choose a random AIFSN value as an integer drawn from a uniform distribution over the interval [N, M], where N and M are predetermined integers specific to an AC. Such a protocol reduces the number of stations within an AC choosing the same AIFSN value by a factor of (M−N+1), thus further reducing the probability of two or more stations choosing the same backoff value as shown in FIG. 2. The reduced packet collision probability results in greater channel access opportunity for the nodes belonging to other ACs.

FIG. 2 is a timing diagram illustrating details of a contention control protocol in accordance with an embodiment of the present invention. As shown, as soon as the medium as noted as idle, information being transmitted for station 1 in access class 1 (“STA-A1”) is postponed for a first random AIFS interval belonging to access class 1 (“AIFS[AC1]A1”). Similarly, information being transmitted for station k in access class 1 (“STA-Ak”) is postponed for a second random AIFS interval belonging to access class 1 (“AIFS[AC1]Ak”). The information being sent by station 1 and the information being sent by station 2 are each additionally postponed for a random number of backoff slots to additionally reduce the likelihood of data collision. As shown, information being transmitted for station 1 in access class 2 (“STA-B1”) is postponed for a first random AIFS interval belonging to access class 2 (“AIFS[AC2]”), which information is of lower priority than the information of access class 1 and which AIFS[AC2] in this embodiment is greater than either AIFS[AC1]A1 and AIFS[AC1]Ak.

A possible advantage of embodiments of the present invention includes improving throughput and delay performances of the IEEE 802.11e wireless network, especially when there are a substantial number of stations per access class. Another possible advantage of embodiments of the present invention includes reducing the number of collisions under such situations, thus leading to an overall improvement in network performance. Further, certain embodiments may come at low cost and may have low overhead. Introducing randomness within a single traffic class may be easily implemented.

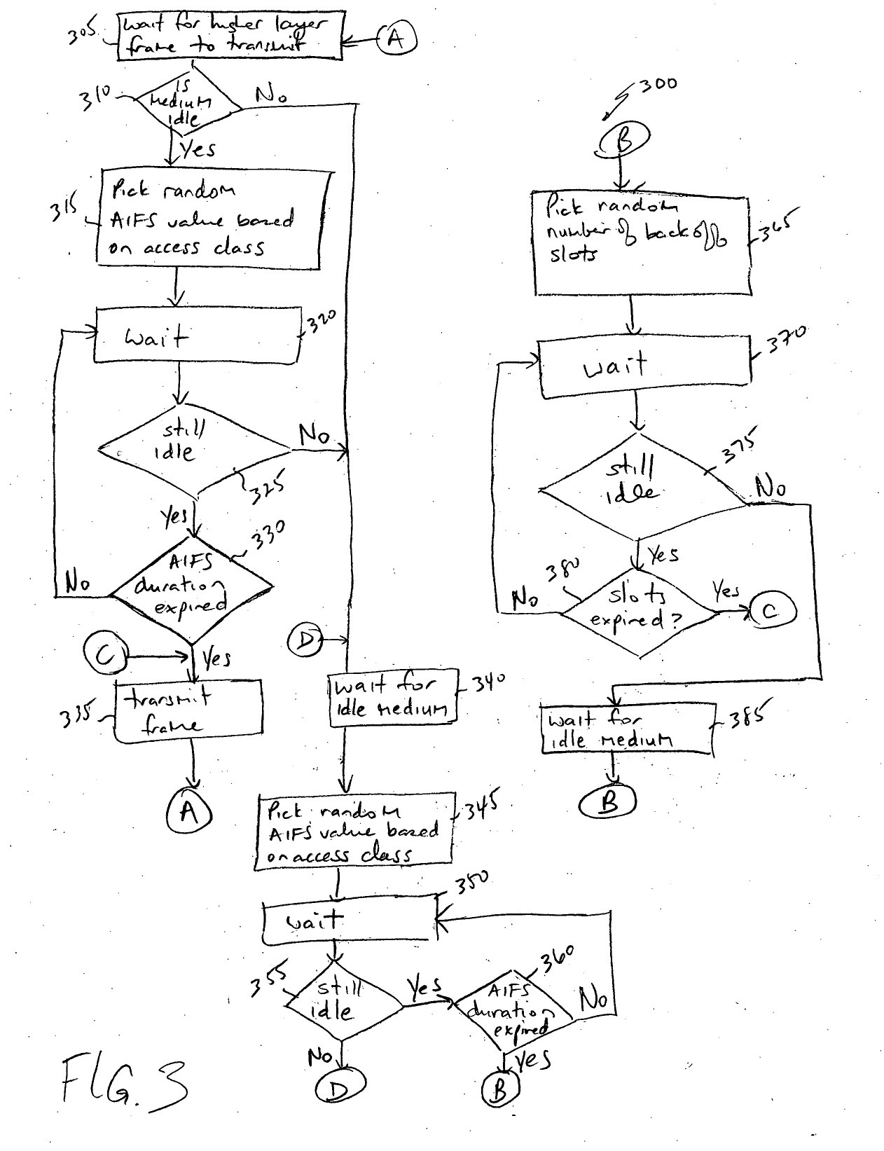

FIG. 3 is a flowchart illustrating details of a method 300 of controlling contention in an channel access system, in accordance with an embodiment of the present invention. Method 300 begins with the station in step 305 waiting for a higher layer frame to transmit. In step 310, the station determines whether the medium is idle.

If in step 310 the station determines that the medium is idle, then the station in step 315 picks a random AIFS value based on the access class of the frame intended for transmission (preferably from a predetermined set of values corresponding to the particular access class). The station in 320 begins to wait for the AIFS duration interval. If in step 325 the station determines that the medium is still idle and in step 330 that the AIFS duration has expired, then the station in step 335 transmits the frame and returns to step 305. If the station in step 330 determines that the AIFS duration has not expired, then the station returns to step 320 to continue waiting. If the station in step 325 determines any time during the AIFS duration interval that the medium is no longer idle, then the method 300 jumps to step 340. Also, if the station in step 310 determines that the medium is not idle, than the method jumps to step 340.

In step 340, the station waits for the medium to go idle. When idle, the station in step 345 picks a random AIFS value based on the access class of the frame intended for transmission. It will be appreciated that this may be or may not be the first time the station is selecting an AIFS value. The station in step 350 begins to wait for the AIFS duration interval to expire. If the station in step 355 determines at any time during the AIFS duration that the medium is no longer idle, then the method returns to step 340 to begin waiting for the medium to go idle again. If the station in step 360 determines that the AIFS duration has not expired, then the method 300 returns to step 350 to continue waiting. When the station in step 360 determines that the AIFS duration has expired and in step 355 that the medium is still idle, then the method 300 jumps to step 365 to begin the backoff process.

In step 365, the station picks a random number of backoff slots and in step 370 begins to wait. If at any time during the backoff duration, the station determines that the medium is no longer idle, then the method 300 jumps to step 385 to wait for the medium to go idle again. Then, the station returns to step 365 to pick another random number of backoff slots. When the station in step 380 determines that the backoff duration has expired and in step 375 that the medium is still idle, then the method jumps to step 335 for the station to transmit the frame. If the station in step 380 determines that the backoff duration has not expired, then the method 300 returns to step 370 to continue waiting.

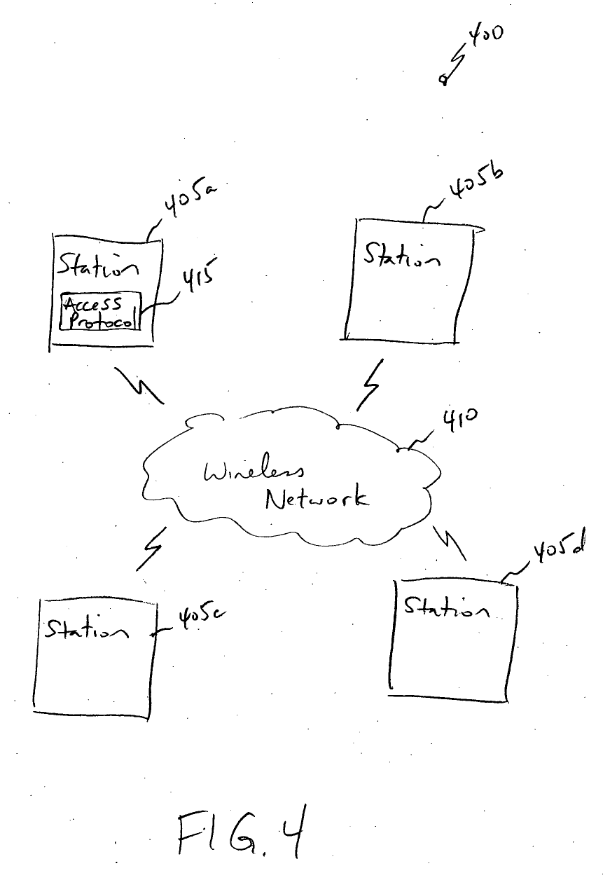

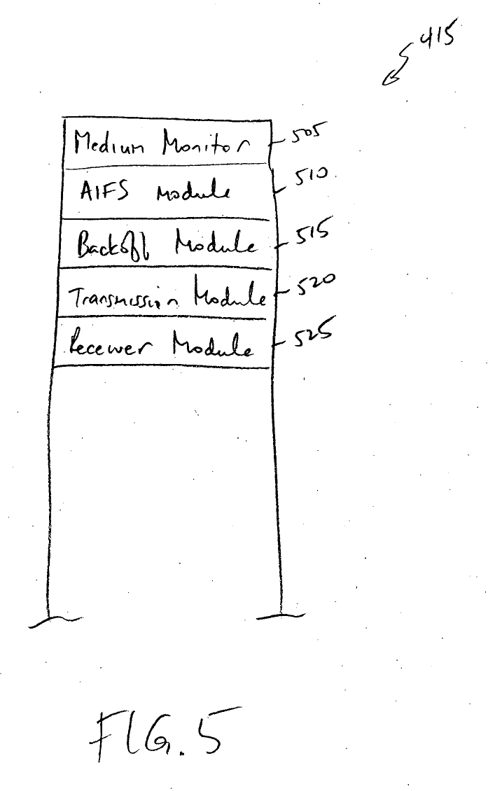

FIG. 4 is a block diagram illustrating a wireless network system 400 in accordance with an embodiment of the present invention. The wireless network system 400 includes four stations 405a-405d, each station 405 having an access protocol module 415 and being connected to the wireless network 410. FIG. 5 illustrates details of the access protocol module 415 in accordance with another embodiment. The access control module 415 includes a medium monitor 505, an AIFS module 510 that performs the steps 305 to 360 (for example), a backoff module 515 that performs steps 365 to 385 (for example), a transmission module 520 that performs step 335 (for example), and a receiver module 525 that receives incoming frames.

Alternative solutions (fixed AIFS interval, CWmin, and TXOP—defined on a per-class basis) are possible for simple multimedia networks but may be unable to handle the multiple streams having the SAME priority—e.g., multiple wireless TV channel distribution within a home.

The foregoing description of the preferred embodiments of the present invention is by way of example only, and other variations and modifications of the above-described embodiments and methods are possible in light of the foregoing teaching. The embodiments described herein are not intended to be exhaustive or limiting. For example, the method may also apply to wired networks. The present invention is limited only by the following claims.

1. A method comprising:
obtaining a frame of information in an access class to be communicated over a wireless channel;
determining whether the wireless channel is idle;
selecting a random arbitration interframe space based on the access class of the frame;
waiting a first time period pertaining to the arbitration interface space; and
initiating communication of the frame of information over the wireless channel after the first time period.

2. The method of claim 1, further comprising
before initiating communication of the frame of information, selecting a random backoff time period;
before initiating communication of the frame of information, waiting a second time period pertaining to the backoff time period.

3. The method of claim 1, wherein the random arbitration interframe space is selected from a predetermined set of values.

4. The method of claim 4, wherein the number of values in the predetermined set is associated with the number of possible stations transmitting in the access class.

5. A system, comprising:
a frame of information in an access class to be communicated over a wireless channel;
a medium monitor for determining whether the wireless channel is idle;
an AIFS module for selecting a random arbitration interframe space based on the access class of the frame and waiting a first time period pertaining to the arbitration interface space; and
a transmission module for initiating communication of the frame of information over the wireless channel after the first time period.

6. The system of claim 5, further comprising
a backoff module for, before initiating communication of the frame of information, selecting a random backoff time period and waiting a second time period pertaining to the backoff time period.

7. The system of claim 5, wherein the random arbitration interframe space is selected from a predetermined set of values.

8. The system of claim 7, wherein the number of values in the predetermined set is associated with the number of possible stations transmitting in the access class.
